(19) United States
(12) Patent Application Publication
(10) Pub. No.: US 2026/0051704 A1
(43) Pub. Date: Feb. 19, 2026

(54) CONNECTOR AND CONNECTOR PAIR

(71) Applicant: Molex, LLC, Lisle, IL (US)

(72) Inventor: Yasushi Sugizuru, Yamato (JP)

(21) Appl. No.: 19/103,836

(22) PCT Filed: Aug. 22, 2023
(86) PCT No.: PCT/IB2023/058345

§ 371 Date: Feb. 14, 2025

(30) Foreign Application Priority Data
Aug. 30, 2022 (JP) 2022-136460

(51) Int. Cl. H01R 13/6598; H01R 12/70; H01R 12/71; H01R 13/504; H01R 13/6594

(52) U.S. Cl. CPC H01R 13/6598; H01R 12/707; H01R 12/712; H01R 13/504; H01R 13/6594

(57) ABSTRACT

A shield includes a main body part, a board connecting part at a first end of the main body part, and a contact point part at a second end of the main body part, and surrounds a periphery of the connector; the main body part, board connecting part, and contact point part include exposed surface exposed outside of a housing; the board connecting part is formed around the entire periphery of the connector; the main body part, board connecting part, and contact point part include a metal base material and first to third plating layers formed on the metal base material; and the first layer is a nickel or nickel alloy plating layer, the second layer is a platinum group metal or platinum group metal plating layer, the third layer is a gold or gold alloy plating layer, and a thickness of the third layer is 0.2 to 15 [nm].

### RELATED APPLICATIONS

This application claims the benefit of and priority to Japanese Patent Application No. 2022-136460 filed Aug. 30, 2022, the contents of which are incorporated by reference in their entirety herein.

### TECHNICAL FIELD

The present disclosure relates to a connector and a connector pair.

### BACKGROUND

Conventionally, board-to-board connectors have been used to electrically connect pairs of parallel circuit boards to each other. This manner of connector includes a plurality of terminals that are conductive members where a board connecting part of each terminal is connected by solder to a wiring pattern or the like formed on a circuit board, and when the connectors are mated and contact point parts of corresponding terminals come into contact with each other, the wiring patterns of the corresponding pair of circuit boards mutually conduct. Furthermore, a barrier is formed on each terminal to prevent spreading of melted solder from the board connecting part to the contact point part (for example, see Patent Document 1).

FIGS. 16A and 16B are diagrams depicting a conventional terminal, where FIG. 16A is a side view and FIG. 16B is a cross section view.

In the diagram, 861 is a terminal mounted in a housing of a connector (not depicted), a member formed by bending a narrow strip shaped conductive metal plate, and includes: a long narrow main body part 861c, a contact point part 861a formed at a first end of the main body part 861c for contacting a counterpart terminal, and a board connecting part 861b formed at a second end of the main body part 861c which is connected by solder to a wiring pattern or the like formed on the circuit board (not depicted).

Furthermore, as depicted in FIG. 16B, the contact point part 861a and the board connecting part 861b have a plurality of plating layers formed thereon. In the diagram, 862 is formed from a metal base material, for example, from a copper alloy such as beryllium copper. In addition, 863a is a nickel plating layer formed as a base layer on the metal base material 862 and the thickness thereof is roughly 2 [μm]. Furthermore, 863b is a palladium plating layer formed on the nickel plating layer 863a and, for example, is composed of a palladium alloy such as Pd—Ni alloy, and the thickness thereof is preferably 0.1 [μm] or more. Furthermore, 863c is a gold plating layer formed on the palladium plating layer 863b and, for example, is composed of a gold alloy such as Au—Co alloy, and the thickness thereof is preferably 0.3 [μm] or more.

As a result, for the contact point part 861a, electrical resistance can be reduced while hardness and wear resistance can be improved, and favorable contact reliability can be obtained. In addition, for the board connecting part 861b, favorable anti-corrosion and solder wettability can be maintained while hardness and wear resistance can be improved. Furthermore, the main body part 861c includes the nickel plating layer 863a and the palladium plating layer 863b formed on the nickel plating layer 863a, but there is no gold plating layer 863c.

In this manner, palladium plating layer 863b, which has inferior solder wettability relative to the gold plating layer 863c, is formed on the surface so the main body part 861c functions as a solder barrier so spreading of melted solder from the board connecting part 861b to the contact point part 861a can be prevented.

### Prior Art Documents

### Patent Documents

[Patent Document 1] Japanese Unexamined Patent Application 2006-294420

### SUMMARY

However, with the conventional connector, a barrier must be formed between the board connecting part 861b and the contact point part 861a and a solder barrier must be formed over a broad area to fully prevent spreading of solder from the board connecting part 861b to the contact point part 861a and this increases the distance from the board connecting part 861b to the contact point part 861a, causing an increase in size of the terminal 861. In particular in recent years, board to board connectors have become smaller and lower in profile so increasing the size of the terminal 861 and lengthening the distance from the board connecting part 861b to the contact point part 861a is difficult. Since the size of the terminal 861 has been reduced in conjunction with size reduction and a lower profile of the board to board connector, the forming of a solder barrier between the board connecting part 861b and the contact point part 861a is difficult.

Herein, to resolve the conventional problems described above, an object is to provide a connector and connector pair having a simple structure, low cost, and high reliability that enable maintaining suitable solder wettability, improving connection strength with a board connecting part, and reducing contact resistance of the contact point part without forming a solder barrier.

To achieve this, a connector includes:
a housing and a shield; wherein
the shield includes a main body part, a board connecting part positioned at a first end of the main body part, and a contact point part positioned at a second end of the main body part, and surrounds a periphery of the connector;
the main body part, board connecting part, and contact point part, each include exposed surface that is exposed outside the housing;
the board connecting part is formed around the entire periphery of the connector;
the main body part, board connecting part, and contact point part each include a metal base material and first to third plating layers formed on the metal base material; and
the first layer is a nickel or nickel alloy plating layer, the second layer is a platinum group metal or platinum group metal alloy plating layer, the third layer is a gold or gold alloy plating layer, and the thickness of the third layer is 0.2 to 15 [nm].

In another connector, the housing is also integrally formed with the shield.

In still another connector, the board connecting part is soldered to the board around the entire periphery.

In still another connector, the board connecting part is a flange that is continuous around the entire periphery.

In still another connector, the contact point part can be molded on the four sides of the shield.

In still another connector, a bent part bent toward the inside of the connector can be formed at an upper end of the shield.

In still another connector, the plating layer is formed over the entirety of the shield.

In still another connector, the thickness of the third layer is 0.5 to 8 [nm].

In still another connector, the platinum group metal is palladium or palladium alloy and the thickness of the second layer is 2 to 200 [nm].

A connector pair includes a connector according to the present disclosure and a mating

connector that mates with the connector.

In another connector pair:
the counterpart connector includes a housing and a shield;
the shield includes a main body part, a board connecting part positioned at a first end of the main body part, and a contact point part positioned at a second end of the main body part, and surrounds a periphery of the counterpart connector;
the main body part, board connecting part, and contact point part each include exposed surface that is exposed outside the housing;
the board connecting part is formed around the entire periphery of the counterpart connector;
the main body part, board connecting part, and contact point part each include a metal base material and first to third plating layers formed on the metal base material; and
the first layer is a nickel or nickel alloy plating layer, the second layer is a platinum group metal or platinum group metal alloy plating layer, the third layer is a gold or gold alloy plating layer, and the thickness of the third layer is 0.2 to 15 [nm].

The connector of the present disclosure enables maintaining suitable solder wettability, improving connection strength of the board connecting part, and reducing contact resistance of the contact point part without forming a solder barrier. In addition, the structure can be simplified, the cost can be reduced, and the reliability is improved.

### BRIEF DESCRIPTION OF THE DRAWINGS

FIG. 1 is an exploded view of the first connector according to the present embodiment.

FIGS. 2A and 2B are a two-view drawing of the first connector according to the present Embodiment, where FIG. 2A is a top view and FIG. 2B is a cross section view taken along the line A-A in FIG. 2A.

FIGS. 3A and 3B are a two-view drawing of the first shield according to the present Embodiment, where FIG. 3A is a top view and FIG. 3B is a cross section view taken along the line B-B in FIG. 3A.

FIGS. 4A and 4B are perspective views of a second connector according to the present Embodiment, where FIG. 4A is a view seen obliquely from above, and FIG. 4B is a view seen obliquely from below.

FIGS. 5A-5C are a three-view drawing of a second connector according to the present Embodiment, where FIG. 5A is a top view, FIG. 5B is a side view, and FIG. 5C is a front view.

FIG. 6 is a bottom view of the second connector according to the present Embodiment.

FIG. 7 is a plan view of an initial mating state of the first connector and second connector according to the present Embodiment.

FIGS. 8A and 8B are cross-sectional views of the initial mating state between the first connector and second connector according to the present Embodiment, where FIG. 8A is a cross section view taken along the line C-C in FIG. 7, and FIG. 8B is a cross section view taken along the line D-D in FIG. 7.

FIG. 9 is a perspective view of the mating completed state of the first connector and second connector according to the present Embodiment.

FIG. 10 is a plan view of the completed mating state of the first connector and second connector according to the present Embodiment.

FIGS. 11A and 11B are side cross section views of the completed mating state between the first connector and second connector according to the present Embodiment, where FIG. 11A is a cross section view taken along the line E-E in FIG. 10, and FIG. 11B is a cross section view taken along the line F-F in FIG. 10.

FIGS. 12A and 12B are lateral cross-sectional views of the completed mating state between the first connector and second connector according to the present Embodiment, where FIG. 12A is a cross section view taken along the line G-G in FIG. 10 and FIG. 12B is a cross section view taken along the line H-H in FIG. 10.

FIG. 13 is a schematic cross section view in the vicinity of the surface of the conductive member depicting a plating layer structure according to the present Embodiment.

FIG. 14 is a diagram depicting test results of solder wetting and spreading according to the present Embodiment.

FIG. 15 is a table depicting test results for changes to the thickness of the second and third layers in the present Embodiment.

FIGS. 16A and 16 B are diagrams depicting a conventional terminal, where FIG. 16A is a side view and FIG. 16B is a cross section view.

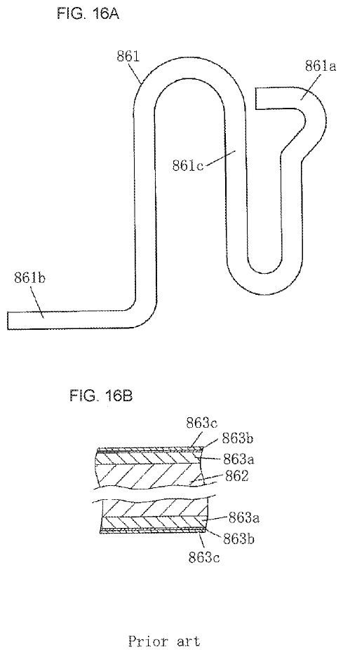

### DETAILED DESCRIPTION

Embodiments will hereinafter be described in detail with reference to the drawings.

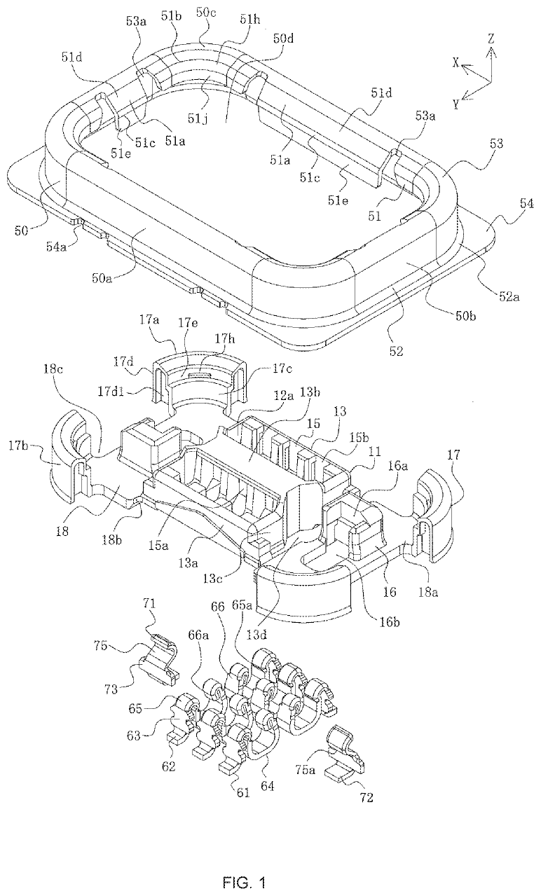

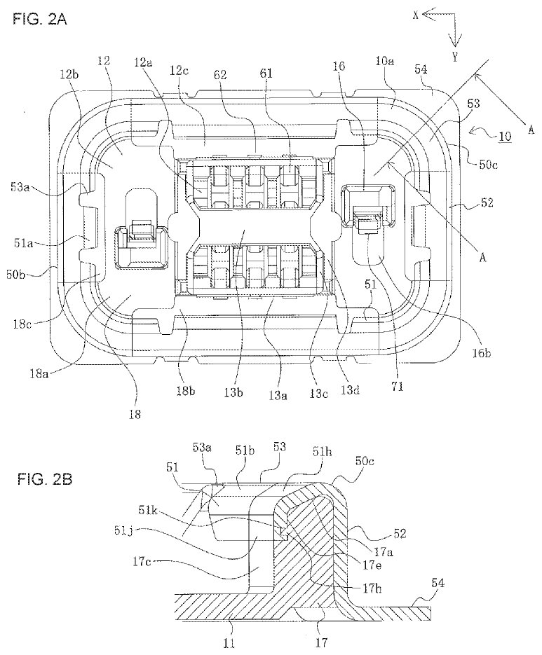

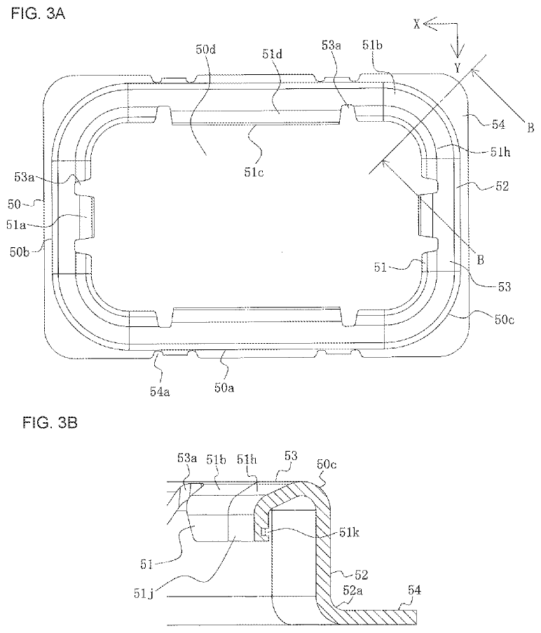

FIG. 1 is an exploded view of the first connector according to the present Embodiment; FIGS. 2A and 2B are a two-view drawing of the first connector according to the present Embodiment; and FIGS. 3A and 3B are a two-view drawing of a first shield according to the present Embodiment. Note that in FIGS. 2A and 2B, FIG. 2A is a top view, and FIG. 2B is a cross section view taken along the line A-A in FIG. 2A. In FIGS. 3A and 3B, FIG. 3A. is a top view, and FIG. 3B is a cross section view taken along the line B-B in FIG. 3A.

In the drawings, 10 is a connector of the present Embodiment and represents a first connector as one of a pair of board to board connectors that are a connector pair. The first connector 10 is a surface mounting type receptacle connector mounted on a surface of a first board (not shown) serving as a mounting member, and is mated together with a second connector 101, described below, serving as a counterpart connector. Furthermore, the second connector 101 is the other of the pair of substrate-to-substrate connectors and is a surface mounting type plug connector mounted on a surface of a second board (not shown) serving as a mounting member.

Note that the first connector 10 and the second connector 101 of the connector pair according to the present Embodiment are preferably used to electrically connect the first board to the second board but can also be used to electrically connect other members. For example, the first board and the second board are each a printed circuit board, a flexible flat cable (FFC), a flexible circuit board (FPC), or the like as used in electronic devices or the like, but may be any type of board.

Furthermore, in the present Embodiment, expressions indicating direction such as up, down, left, right, front, rear, and the like used to describe a configuration and operation of each part of the connector pair first connector 10 and the second connector 101 are relative rather than absolute and are appropriate when each part of the first connector 10 and the second connector 101 are in positions depicted in the drawings. However, these directions should be interpreted as changing in accordance with a change in position when the position thereof is changed.

Furthermore, the first connector 10 has: a first shield 50 as a first outer side shield, which is a shield formed by punching, drawing, or the like process on a conductive metal plate; and a first housing 11 as a housing integrally formed by an insulating material such as a synthetic resin or the like. The first housing 11 has a flat bottom plate 18, a first protruding part 13 protruding as a part upward from an upper surface of the bottom plate 18, and corner parts 17 protruding upward from four corners of the bottom plate 18.

The corner part 17 is a portion that is connected to the first shield 50 when the first shield 50 is integrated with the first housing 11 by over-molding or insert molding. In the present Embodiment, the first housing 11 is integrally molded with the first shield 50. In other words, the first housing 11 is molded by filling a cavity of a mold in which the first shield 50 is internally set in advance, with an insulating material such as synthetic resin or the like, and is integrally connected to the first shield 50 at the corner part 17. Therefore, the first housing 11 and first shield 50 do not exist separately; however, the first housing 11 and first shield 50 are depicted as existing separately in FIG. 1 for convenience of description.

As depicted in FIG. 1, each of the corner parts 17 includes an upper wall part 17a shaped like one of four sections of a cylindrical wall, having an arc shape with a central angle of approximately 90 degrees in plan view; a cylindrical outer wall part 17b extending downward (Z-axis, negative direction) from the outer edge of the upper wall part 17a; a cylindrical inner wall part 17c extending downward from the inner edge of the upper wall part 17a; and a pair of flat side wall parts 17d extending downward from the edge of the upper wall 17a corresponding to the two ends of an arc with a central angle of approximately 90 degrees. Note that in the example depicted in FIG. 1, a recessed entry part 17d1 with recessed entry excluding the peripheral edge is formed in each side wall part 17d, but the recessed entry part 17d1 can be omitted, and the side wall part 17d can be flat.

Furthermore, the inner wall part 17c has a shield stowing part 17e recessed to house the inner wall 51 at the corner part 50c included in the mating positioning part 51b of the first shield 50. The lower end part of the shield stowing part 17e is formed so as to be substantially flush with the upper surface of the bottom plate 18 connecting part 18a. Furthermore, as depicted in FIG. 1 and FIG. 2B, a locking protruding part 17h is preferably formed so as to protrude toward the inside of the stowing part 50d, for at least a portion of the vicinity of the lower end part of the shield stowing part 17e.

In addition, a lower end part of a corner part 50c included in the mating positioning part 51b of the first shield 50 is formed substantially flush with an upper surface of a flange part 54. Furthermore, the upper end vicinity of the mating positioning part 51b that includes the corner part 50c has a gradual oblique surface part 51h that is sloped gradually facing downward toward the inside of the stowing part 50d.

Note that the mating positioning part 51b includes a positioning lower part 51j that extends downward substantially vertically from the lower end of the gradual oblique surface part 51h. Furthermore, as depicted in FIG. 3B, the inner wall surface of the positioning lower part 51j, or in other words at least a portion in the vicinity of the lower end part of the wall surface that faces the outer wall 52, preferably has a locking recessed part 51k with groove entry that is formed toward the inside of the stowing part 50d.

Therefore, as depicted in FIG. 2B, when the first shield 50 is integrated with the first housing 11 by over-molding or insert molding, a portion of the constituent material of the first housing 11 that is filled on the back side of the corner parts 50c penetrates into the locking recessed part 51k, forming the locking protruding part 17h, and thus the locking protruding part 17h and the locking recessed part 51k will engage together. Therefore, the corner parts 50c and the corner part 17 will be securely integrated and cannot separate. Note that the outer wall surface of the positioning lower part 51j, or in other words the wall surface facing the inside of the stowing part 50d is essentially on the same plane extending in a vertical direction from the inner wall part 17c of the corner part 17.

The first protruding part 13 is an essentially rectangular-shaped member extending in the longitudinal direction (X-axis direction) of the first connector 10, and includes a pair of outer side protruding parts 13a extending in the longitudinal direction of the first connector 10 on both sides in the width direction (Y-axis direction) of the first connector 10, a pair of inner side protruding parts 13b extending in the longitudinal direction of the first connector 10 at the center in the width direction, and a pair of transverse protruding parts 13c that connect the two ends of the outer side protruding parts 13a and the inner side protruding parts 13b in the longitudinal direction. Furthermore, a pair of inner recessed groove parts 12a, which are recessed parts extending in the longitudinal direction of the first connector 10, are formed as a portion of the first recessed part 12 between the outer side protruding parts 13a on both sides to the left and right of the inner side protruding part 13b.

Here, a first signal terminal stowing cavity 15 is formed from both left and right side surfaces of the inner side protruding part 13b, along the bottom surface of the inner recessed groove part 12a, and to the side surface of the outer side protruding part 13a. In the depicted example, the first signal terminal stowing cavities 15 pass through the bottom plate 18 in the plate-thickness direction (Z-axis direction). Note that, of the first signal terminal stowing cavities 15, recessed groove parts formed on both side surfaces on the left and right of the inner side protruding part 13b are referred to as a first signal terminal housing inner side cavity 15a, and recessed groove parts formed on side surfaces facing the inner side protruding part 13b at the outer side protruding part 13a are referred to as a first signal terminal housing outer side cavity 15b.

A plurality (three in the example depicted in the figure) of the first signal terminal stowing cavities 15 are formed at a prescribed (for example, 0.35 [mm]) pitch in a longitudinal direction. Note that the pitch and the number of the first signal terminal stowing cavities 15 can be changed as appropriate. A plurality of first terminals 61, which are terminals housed in each of the first signal terminal stowing cavities 15 and attached to the first housing 11, are also provided at a similar pitch on both sides of the first protruding part 13. In other words, a plurality of first terminals 61 are provided along each inner recessed groove part 12a to form a pair of parallel terminal group rows.

Furthermore, second shield housing slits 13d are formed as a slit into which enters an inner wall 151, of the second shield 150 of the second connector 101, described below, on the outer side of both ends in the longitudinal direction of the first protruding part 13, or in other words, on the outside of the lateral protruding part 13c. In the example depicted in the figure, the second shield housing slit 13d is formed to penetrate the bottom plate 18 in the direction of the plate thickness, but the slit does not necessarily penetrate the bottom plate 18 in the direction of the plate thickness.

A side recessed part 18b is formed in the bottom plate 18 on the outer side of the first protruding part 13 in the width direction of the first connector 10, and as a result, the bottom plate 18 has a smaller dimension in the width direction of the first connector 10, or in other words, is formed to a narrow width. In addition, end recessed parts 18c are formed at both ends of the bottom plate 18 in the longitudinal direction of the first connector 10, and therefore, the bottom plate 18 has a small dimension in the longitudinal direction of the first connector 10, or in other words, is formed to be short.

Furthermore, first high-frequency terminal supporting parts 16 serving as a pair of supporting parts protruding upwardly from the upper surface of the bottom plate 18 are formed more on an outer side of the first protruding part 13 with regard to the longitudinal direction of the first connector 10. The first high-frequency terminal supporting parts 16 have a shape when viewed from above that is an essentially U-shaped columnar member as depicted in FIG. 2A and have a first high-frequency terminal stowing groove 16a serving as a high-frequency terminal stowing groove extending in the vertical direction. In addition, the first high-frequency terminal supporting parts 16 are disposed such that openings of the respective first high-frequency terminal stowing grooves 16a face opposite directions and, as depicted in FIG. 2A, are disposed so as to be point-symmetrical with regard to a center of the first connector 10 when viewed from above, in other words, in plan view, and so as to be separated from the center of the first connector 10 in the width direction and deflected to an outer side in the width direction. Furthermore, a first high-frequency terminal 71 serving as a high-frequency terminal is stowed in the first high-frequency terminal stowing grooves 16a. Furthermore, first high-frequency terminal stowing openings 16b serving as an opening penetrating the bottom plate 18 in the plate thickness direction is formed below and in front of the first high-frequency terminal stowing grooves 16a.

The first shield 50 is a member integrally formed by punching, drawing, and the like processing a conductive metal plate that is a curvilinear member extending in the mating direction of the first connector 10 so the surface can be said to be an extension surface. In addition, as depicted in FIG. 2A and as viewed from above, in other words in plan view, the first shield 50 is a substantially rectangular shaped frame-like member that surrounds the periphery of the first connector 10 and encloses the periphery of the first housing 11. Furthermore, the first shield 50 includes an oblique surface part 51d and a gradual oblique surface part 51h as inclined parts extending obliquely downward and formed on the inner peripheral edge of the upper end thereof. Furthermore, the first shield 50 includes a plurality of (one pair in the example depicted in the figure) long side parts 50a as linear parts extending linearly in the longitudinal direction of the first connector 10, a plurality of (one pair in the example depicted in the figure) short side parts 50b as linear parts extending linearly in the width direction of the first connector 10, and a plurality (four in the example depicted in the figure) of corner parts 50c as bent parts that are curved by approximately 90 degrees that connect one end of the long side part 50a and one end of the short side part 50b.

Furthermore, the first shield 50 contains: an outer wall 52; an inner wall 51 essentially parallel to the outer wall 52 on an inner side of the outer wall 52; and a connecting part 53 that connects and integrates an upper end of the outer wall 52 with an upper end of the inner wall 51. This connecting part 53 is a bent part at the upper end of the first shield 50 that curves toward the inside of the first connector 10. While the outer wall 52 is a wall that is contiguous over the entire circumference, the inner wall 51 has slits 53a formed near the corner parts 50c of the long side parts 50a and the short side parts 50b such that a mating spring part 51a and a mating positioning part 51b are separated. Note that an enclosed space surrounded on the circumference by the portions corresponding to the long side part 50a, the short side part 50b and the corner part 50c of the inner wall 51 is a stowing part 50d in which the second connector 101, which is a counterpart connector, is inserted and stowed.

The mating spring part 51a is a portion extending linearly within the range of each long side part 50a and within the range of each short side part 50b, and when the first connector 10 and the second connector 101 are in a mated state, the mating spring part elastically contacts an outer wall 152, described below, of the second shield 150 of the second connector 101 and functions as a ground spring that maintains the conductive state between the first shield 50 and the second shield 150. Furthermore, the mating positioning part 51b is a portion where a portion of the long side part 50a and a portion of the short side part 50b are connected to both sides of the curved corner part 50c, and when the first connector 10 and the second connector 101 are mated, guides the second connector 101 that is inserted into the stowing part 50d. Specifically, the second connector 101 is inserted into the stowing part 50d while the outer wall 152 of the second shield 150 is in contact with the mating positioning part 51b, thereby positioning is performed between the second connector 101 and the first connector 10.

Furthermore, the upper end of the mating spring part 51a is connected to the lower end of the connecting part 53, and contains the oblique surface part 51d that extends obliquely downward to the inside of the stowing part 50d, an engaging protruding part 51c formed on a lower end of the oblique surface part 51d and protruding to the inside of the stowing part 50d, and an inner wall lower part 51e extending substantially vertically downward from the lower end of the engaging protruding part 51c. With the first connector 10 and the second connector 101 in a mated state, the engaging protruding part 51c is a portion that engages and makes contact with the outer wall 152 of the second shield 150 of the second connector 101, or engaging protruding part 152c, described below, formed on this outer wall 152, and functions as a contact point part. Note that the engaging protruding part 51c extends linearly in the longitudinal direction or the width direction of the first connector 10. The mating spring parts 51a are not connected to the first housing 11, but are relatively flexible and can be elastically deformed in a direction of approaching or separating from the outer wall 52, since both ends are separated from another portion by the slit part 53a.

The vicinity of the upper end of the mating positioning part 51b is a coupling part of the upper end of the inner wall 51 on the connecting part 53, and forms the gradual oblique surface part 51h that slopes gradually downward toward the inside of the stowing part 50d. Therefore, when viewed in the longitudinal direction and width direction of the first connector 10, the oblique angle of the gradual oblique surface part 51h, or in other words, the taper angle, is more gentle than the taper angle of the mating spring part 51a oblique surface part 51d, and when the first connector 10 and the second connector 101 are mated together, the gradual oblique surface part 51h contacts the second connector 101 that is inserted into the stowing part 50d, and subsequently, the oblique surface part 51d makes contact. Thereby, the damage to the mating spring part 51a can be reduced when the first connector 10 and the second connector 101 are mated.

In addition, a corner part 50c included in the mating positioning part 51b is a portion that is connected to the first housing 11 when the first shield 50 is integrated with the first housing 11 by over-molding or insert molding, and specifically, is a portion that is integrated with the corner part 17. Note that the other portions in the first shield 50 are separated from the first housing 11. Therefore, when the first shield 50 and the first housing 11 are integrated, the outer wall 52 and the connecting part 53 at the corner part 50c cover the outer wall part 17b and the upper wall part 17a at the corner part 17. Furthermore, the inner wall 51 at the corner part 50c is housed within the shield stowing part 17e formed in the inner wall part 17c at the corner part 17.

This ensures that the corner part 50c and corner part 17 are firmly integrated and cannot be separated. Furthermore, the corner part 50c is integrated with the corner part 17 of the first housing 11, and at least the space demarcated by the outer wall 52, the inner wall 51, and the connecting part 53 is filled with an insulating material that constitutes the first housing 11. In other words, the corner part 50c is robust because the backside is filled with the constituent material of the first housing 11. Furthermore, the mating positioning part 51b including the corner part 50c has high robustness, and therefore, even if the portion near the mating surface 101a of the second shield 150 of the second connector 101, which will be described later, comes into contact with the mating positioning part 51b, the mating positioning part 51b will not be deformed or damaged.

A flange part 54 serving as an outwardly extending flat part is connected to the lower end of the outer wall 52 through the bent part 52a bent at an angle of approximately 90 degrees. The bent part 52a and the flange part 54 are connected to the lower end of the outer wall 52 in a continuous manner around the entire circumference. Note that in the example depicted in the drawings, a small notch 54a is formed in a plurality of locations on the flange part 54, but the notch 54a can be omitted as appropriate.

The flange part 54 functions as a board connecting part, a lower surface of which is parallel to the surface of the first board and is a portion connected by soldering or the like to the connection pad on the surface. Note that in a comprehensive description, the area where the engaging protruding part 51c is formed as a contact point part on the inner wall 51, including the connecting part 53 and outer wall 52, and the flange part 54 as the board connecting part, are described as a main body part. The connection pad is typically connected to a ground line. Furthermore, the outer wall 52 is a continuous wall along the entire periphery thereof; the upper end thereof is connected to a portion that is continuous with the connecting part 53, the portion including a location extending in cross section in a direction orthogonal to the outer wall 52; the lower end thereof is connected to a member that is continuous similar to the flange part 54 that extends in cross section in a direction orthogonal to the outer wall 52; and therefore, rigidity thereof is relatively high, and deformation does not readily occur.

Furthermore, when the first housing 11 is connected to the first shield 50 in the stowing part 50d, a first recess 12 that mates with the second connector 101 is formed in the stowing part 50d, which is a recess with a circumference surrounded by the inner wall 51 and a lower portion is demarcated by the bottom plate 18. Furthermore, as described above, the inner recessed groove parts 12a which are long narrow recessed parts extending in the longitudinal direction of the first connector 10 are formed as a portion of the first recessed part 12, between the outer side protruding parts 13a on both sides to the left and right of the inner side protruding part 13b. Furthermore, an outer recessed groove part 12c, which is an elongated recessed part extending in the longitudinal direction of the first connector 10, is formed between the outer side protruding parts 13a and the inner wall 51 as a portion of the first recessed part 12. Furthermore, mating recessed parts 12b are formed at two outer ends of the first protruding part 13 with regard to the longitudinal direction of the first connector 10 as a portion of the first recessed part 12.

Furthermore, the first terminal 61 is a member integrally formed by punching, bending, or the like process on a conductive metal plate, and is provided with the retained part 63, the tail part 62 serving as a board connecting part connected to a lower end of the retained part 63, an outer side connecting part 65 connected to an upper end of the retained part 63, and a lower connecting part 64 connected to a lower end of the outer side connecting part 65 having an essentially U-shaped side surface shape. The contacting part 65a curved so as to swell inward in the width direction of the first connector 10 is formed in the vicinity of the lower end of the outer side connecting part 65. Furthermore, the first terminal 61 is further provided with an inner side connecting part 66 connected to a tip end of the lower connecting part 64. The inner side connecting part 66 is bent and connected to the lower connecting part 64, and extends upwardly (Z-axis positive direction). A contacting part 66a curved so as to bulge outwardly in the width direction of the first connector 10 is formed in the vicinity of an upper end of the inner side connecting part 66. The contacting part 66a is similar to the contacting part 65a of the outer side connecting part 65, and is a portion that contacts the second terminal 161 provided in the second connector 101 as described below. In other words, the first terminal 61 in the present Embodiment is provided with the contacting part 65a of the outer side connecting part 65 and the contacting part 66a of the inner side connecting part 66, which face each other, and is configured to make two-point contact with the second terminal 161. When the first terminal 61 is mounted in the first housing 11, the contacting part 65a of the outer side connecting part 65 and the contacting part 66a of the inner side connecting part 66 protrude into the inner recessed groove part 12a so as to be facing each other.

Furthermore, the first terminal 61 is press-fitted into the first signal terminal stowing cavity 15 from a mounting surface 10b side, which is a lower surface (Z-axis, negative direction surface) of the first connector 10, and is fixed to the first housing 11 based on the retained part 63 being sandwiched from two sides by the inner side surfaces of the first signal terminal housing outer side cavity 15b. Note that the first terminal 61 is not required to be attached to the first housing 11 by press fitting, but may be integrated with the first housing 11 by over-molding or insert molding. Here, for convenience of description, a case in which the retained part 63 is pressed into and retained by the first signal terminal housing outer side cavity 15b will be described.

The tail part 62 is bent and connected to the retained part 63, extends in a left-right direction (Y-axis direction), in other words, outward in the width direction of the first connector 10, and is connected to the connection pad connected to a conductive trace of the first board by soldering or the like. Note that the conductive trace may be a power line that supplies power, but is typically a signal line. In addition, the signal line is described assuming that the signal line does not transmit a high-frequency signal, but rather transmits a signal of normal frequency (for example, frequency less than 10 [GHz]), which is lower in frequency than high-frequency signals. Note that the tail part 62 is visible when viewed from a mating direction of the first connector 10, in other words, from a mating surface 10a side.

The first high-frequency terminal 71 is a member integrally formed by punching, bending, or the like process on a conductive metal plate, and has a retained part 73, a tail part 72 serving as a board connecting part connected to a lower end of the retained part 73, and an upper connecting part 75 connected to an upper end of the retained part 73.

Furthermore, the retained part 73 extends in the vertical direction (Z-axis direction) and is a portion that is press-fitted and retained in the first high-frequency terminal stowing groove 16a. As described above, the first high-frequency terminal supporting parts 16 are disposed such that the openings of the respective first high-frequency terminal stowing grooves 16a face opposite directions, and therefore, the first high-frequency terminals 71 retained in the first high-frequency terminal stowing grooves 16a by the retained part 73 are also in a position so as to face each other in opposite directions. Note that the first high-frequency terminal 71 is not necessarily attached to the first housing 11 by press fitting but may be integrated with the first housing 11 by over-molding or insert molding. Herein, for convenience of description, a case in which the retained part 73 is pressed into and retained by the first high-frequency terminal stowing groove 16a will be described.

The tail part 72 is bent and connected to the retained part 73, extends in a left-right direction (Y-axis direction), in other words, toward the center in the width direction of the first connector 10, and is connected to the connection pad connected to a conductive trace of the first board by soldering or the like. Note that the aforementioned conductive traces are signal lines, which are typically described as transmitting high-frequency signals of high-frequency (for example, frequency of 10 [GHz] or higher), such as RF signals.

Furthermore, the upper connecting part 75 is bent in an approximate S-shape when viewed from the longitudinal direction of the first connector 10, and a portion bent so as to bulge out toward the center in the width direction of the first connector 10 functions as a contacting part 75a. The contacting part 75a is a portion in contact with a second high-frequency terminal 171, described below, provided on the second connector 101.

The first high-frequency terminal 71 is press-fitted from the mounting surface 10b side into the first high-frequency terminal stowing groove 16a of the first high-frequency terminal supporting part 16 positioned in the mating recessed part 12b and is fixed to the first housing 11 based on the retained part 73 being sandwiched from two sides by inner side surfaces of the first high-frequency terminal stowing groove 16a. In this state, in other words, in a state in which the first high-frequency terminals 71 are installed in the first housing 11, the contacting parts 75a of the pair of first high-frequency terminals 71 face mutually opposite directions.

Furthermore, the first connector 10 is placed on the surface of the first board with a first solder sheet (not shown) serving as a solder sheet applied to the mounting surface 10b side and is fixed and mounted on the surface of the first board by heating and melting the first solder sheet using a heating furnace or the like. Note that the means for connecting the first shield 50, first terminal 61, first high-frequency terminal 71, and the like to the connection pad or the like of the first board does not necessarily have to be application of a solder sheet, and may be application of solder paste, transfer of cream solder, dipping, jet soldering, or the like; however, for convenience of description, the case of using a solder sheet will be described.

The first solder sheet contains: a pair of elongated strip shaped long side portions extending linearly and continuously in the longitudinal direction of the first connector 10; a pair of elongated strip shaped short side portions extending linearly and continuously in the width direction of the first connector 10; and a plurality of rectangular short length portions in which a long side extends in the width direction of the first connector 10 and a short side extends in the longitudinal direction of the first connector 10. Note that two ends of each short side portion are preferably connected to the long side portions. Furthermore, the long side portion and short side portion do not necessarily have to extend continuously and may be intermittent but will be described herein as extending continuously.

Furthermore, a pair of long side portions are attached to the bottom surface of the flange part 54 corresponding to the long side parts 50a of the first shield 50. A pair of short side portions are attached to the bottom surface of the flange part 54 corresponding to the short side parts 50b of the first shield 50. Furthermore, each short length portion is provided on a lower surface of the tail part 62 of each first terminal 61 and to a lower surface of the tail part 72 of each first high-frequency terminal 71.

When the first connector 10 is mounted on the surface of the first board by heating and melting a first solder sheet applied in this manner, the flange part 54, which is connected continuously around the entire periphery, is connected without a gap to connection pads on the surface of the first board at the bottom of the outer wall 52, which is connected continuously around the entire periphery, of the first shield 50. Therefore, the strength of the first shield 50 connected to the connection pads on the surface of the first board is high, and consequently, the strength of the entire first connector 10 with an outer circumference surrounded by the first shield 50 is high. Furthermore, an electromagnetic shielding effect exerted by the first shield 50, which is connected without a gap to the connection pads on the surface of the first board, is very high, and the first connector 10 with an outer circumference surrounded by the first shield 50 is very effectively electromagnetically shielded. In particular, the smoothness of the lower surface of the flange part 54 is high. Thus, the strength of the first shield 50 connected to the connection pads on the surface of the first board can be made extremely high. Moreover, since no gap is created between the connection pads on the surface of the first board, the electromagnetic shielding effect can also be made extremely high.

Thus, the first connector 10 can transmit a high-frequency signal even with a compact and low profile, because the strength and the electromagnetic shielding effect are high. For example, even if the dimensions in the longitudinal, width, and height directions of the first connector 10 are set to 3.3 [mm] or less, 2.3 [mm] or less, and 0.7 [mm] or less, the first high-frequency terminal 71 can transmit a high-frequency signal of approximately 60 [GHz].

### Next, the Configuration of the Second Connector 101 Will Be Described.

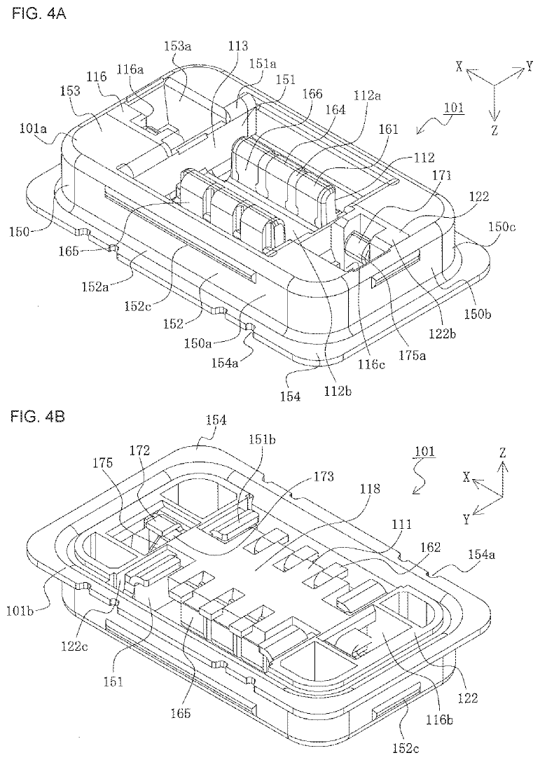

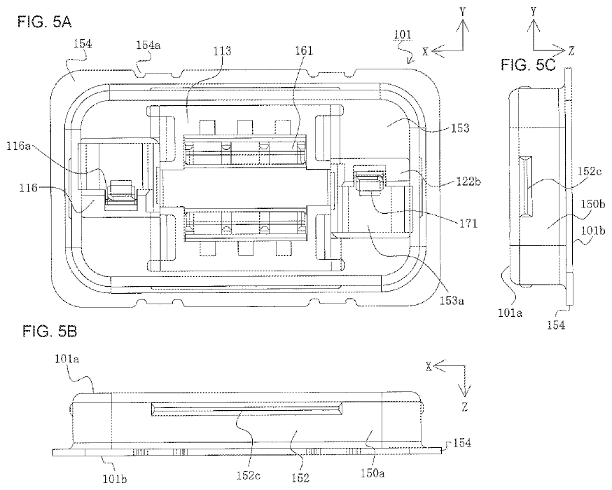

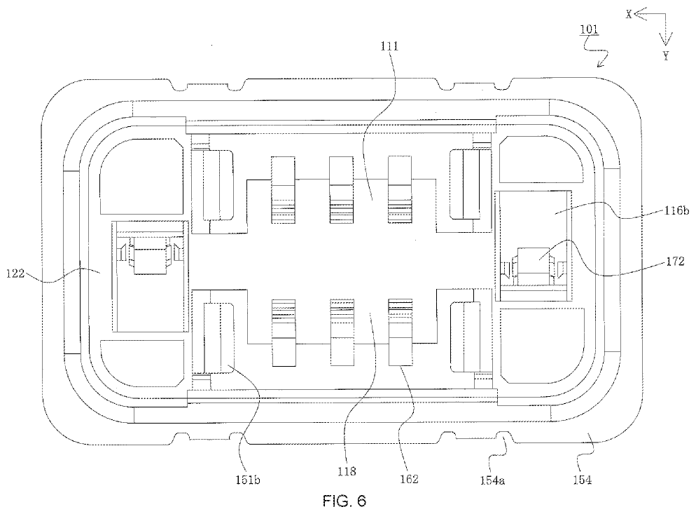

FIGS. 4A and 4B are perspective views of the second connector according to the present embodiment; FIGS. 5A-5C are a three-view drawing of the second connector according to the present Embodiment; and FIG. 6 is a bottom view of the second connector according to the present Embodiment. Note that in FIGS. 4A and 4B, FIG. 4A is a view seen obliquely from above, FIG. 4B is a view seen obliquely from below, and in FIGS. 5A-5C, FIG. 5A is a top view, FIG. 5B is a side view, and FIG. 5C is a front view.

The second connector 101 according to the present Embodiment includes: a second shield 150 as a second outer side shield, which is a shield formed by punching, drawing, or the like process on a conductive metal plate; and a second housing 111 as a housing integrally formed using an insulating material such as a synthetic resin or the like. The second housing 111 has: a flat bottom plate 118; a second protruding part 112 serving as a protrusion protruding upwardly from an upper surface of the bottom plate 118 in a center in a longitudinal direction of the second connector 101; and a pair of protruding end parts 122 protruding upwardly from the upper surface of the bottom plate 118 at two ends in the longitudinal direction (X-axis direction) of the second connector 101. The second protruding part 112 is narrower than the protruding end part 122 and is positioned more on an inner side in a width direction (Y-axis direction) of the second connector 101 than two ends of the protruding end part 122.

The second protruding part 112 is an essentially rectangular member extending in the longitudinal direction of the second connector 101. A groove shaped center groove 112b recessed downwardly from an upper surface is formed in a center in the width direction, and portions on two sides on the left and right of the center groove 112b are terminal supporting walls 112a supporting the second terminal 161 serving as a mating terminal. The second terminals 161 are provided at a pitch corresponding to the first terminals 61 at a number corresponding to the first terminals such that at least a portion of the second terminals 161 are exposed on the surface of the terminal supporting wall 112a. In other words, a plurality of the second terminals 161 are disposed along each terminal supporting wall 112a to form a pair of parallel terminal group rows (mating terminal group rows).

Each protruding end part 122 contains: an outer wall surface that faces an outer side in the longitudinal direction and two sides in the width direction of the second connector 101; an upper surface 122b that faces the mating surface 101a side of the second connector 101; and an inner wall surface 122c that faces an inner side in the longitudinal direction of the second connector 101. Note that each of the protruding end parts 122 is separated from two ends in the longitudinal direction of the second protruding part 112. Furthermore, a second high-frequency terminal supporting part 116 serving as a supporting part is formed on each protruding end part 122. The second high-frequency terminal supporting part 116 has second high-frequency terminal stowing grooves 116a serving as a high-frequency terminal stowing groove extending in the vertical direction and has an essentially U-shaped shape when viewed from above. In addition, the second high-frequency terminal supporting parts 116 are disposed such that openings of the respective second high-frequency terminal stowing grooves 116a face opposite directions and, as depicted in FIG. 5A, are disposed so as to be point-symmetrical with regard to a center of the second connector 101 when viewed from above, in other words, in plan view, and so as to be separated from the center of the second connector 101 in the width direction and deflected to an outer side in the width direction. Furthermore, a second high-frequency terminal 171 serving as a high-frequency terminal is stowed in the second high-frequency terminal stowing grooves 116a. Furthermore, a second high-frequency terminal stowing opening 116b serving as an opening penetrating the bottom plate 118 in the plate thickness direction is formed below and in front of the second high-frequency terminal stowing grooves 116a. Furthermore, on each of the protruding end parts 122, a first high-frequency terminal stowing recessed part 116c, serving as a mating terminal stowing recessed part opened in an upper surface 122b from the second high-frequency terminal stowing opening 116b to the upper surface 122b, is formed in front of the second high-frequency terminal stowing grooves 116a.

The second shield 150 is a member integrally formed by punching, drawing, and the like processing a conductive metal plate that is a curvilinear member extending in the mating direction of the second connector 101 so the surface can be said to be an extension surface. In addition, in plan view, the second shield 150 is a substantially rectangular frame-like member, and surrounds the periphery of the second connector 101 and encloses the periphery of the second housing 111. Furthermore, the second shield 150 contains: a pair of long side parts 150a extending linearly in the longitudinal direction of the second connector 101; a pair of short side parts 150b extending linearly in the width direction of the second connector 101; and four corner parts 150c bent approximately 90 degrees connecting one end of the long side part 150a and one end of the short side part 150b.

Furthermore, the second shield 150 contains: an outer wall 152; an inner wall 151 serving as a second inner second inner side shield; and an upper wall 153. Furthermore, the outer wall 152 is a continuous wall over an entire circumference. Furthermore, the upper wall 153 is connected to an upper end of the outer wall 152 at each of the short side parts 150b, the corner parts 150c at two ends of the short side parts 150b, and in the vicinity of two ends of each of the long side parts 150a and is formed so as to cover at least a portion, preferably a majority, of the upper surface 122b of the protruding end part 122. Note that the first high-frequency terminal stowing opening 153a is formed in the upper wall 153, which serves as an opening corresponding to the first high-frequency terminal stowing recessed part 116c. Furthermore, the inner wall 151 extends downwardly with an upper end thereof connected to an inner side end in the longitudinal direction of the second connector 101 on the upper wall 153 and is formed so as to cover at least a portion, preferably essentially entirely, of the inner wall surface 122c of the protruding end part 122. Note that an upper end of the inner wall 151 has a bent upper wall connecting part 151a that is connected to the upper wall 153, and a lower end of the inner wall 151 has a tail part 151b serving as a board connecting part that is bent such that a tip end faces to an inner side in the longitudinal direction of the second connector 101. The tail part 151b is parallel to the surface of the second board and is a portion connected by soldering or the like to the connection pad on the surface. The connection pad is typically connected to a ground line. Furthermore, a space with a circumference surrounded by the outer wall 152 corresponding to the pair of long side parts 150a and the pair of inner walls 151 is a second recessed part 113 into which the first protruding part 13 of the first connector 10 is inserted and stowed.

A flange part 154 serving as a flat part is connected to the lower end of the outer wall 152 through the bent part 152a bent at an angle of approximately 90 degrees. The bent part 152a and the flange part 154 are connected to the lower end of the outer wall 152 in a continuous manner around the entire circumference. Note that in the example depicted in the drawings, a small notch 154a is formed in a plurality of locations on the flange part 154, but the notch 154a can be omitted as appropriate.

The flange part 154 functions as a board connecting part, a lower surface of which is parallel to the surface of the second board and is a portion connected by soldering or the like to the connection pad on the surface. The connection pad is typically connected to a ground line. Furthermore, the outer wall 152, in addition to being a continuous wall over the entire circumference itself, is connected to a member where a lower end thereof is continuous as with the flange part 154, which is a member extending in a direction orthogonal to the outer wall 152 in the cross section. Therefore, the outer wall 152 is relatively rigid and resistant to deformation. In the present Embodiment, an example is described where the flange part 154 is connected to the lower end of the outer wall 152 continuously over the entire circumference, but the flange part 154 may be connected only to a portion if relatively high rigidity is not required.

Furthermore, the outer wall 152 corresponding to the long side part 150a, and the short side part 150b may include the outwardly protruding engaging protruding part 152c. The engaging protruding part 152c is a portion that engages and is in contact with the engaging protruding part 51c formed on the inner wall 51 of the first shield 50 provided by the first connector 10 when the first connector 10 and the second connector 101 are mated with each other, functions as a contact point part, and extends linearly in the longitudinal and width directions of the second connector 101. Furthermore, in a comprehensive description, the area from where the engaging protruding part 152c is formed as a contact point part on the outer wall 152 to the flange part 154 as a board connecting part is described as a main body part.

Note that the second shield 150 is integrated with the second housing 111 by over-molding or insert molding. In the present Embodiment, the second housing 111 is integrally molded with the second shield 150. In other words, the second housing 111 is molded by filling a cavity of a mold in which the second shield 150 is internally set in advance, with an insulating material such as synthetic resin or the like, and is integrally connected to the second shield 150 at the protruding end part 122.

The second terminal 161 is a member integrally formed by punching, bending, or the like process on a conductive metal plate, and has:
an outer side connecting part 165 extending in the vertical direction (Z-axis direction),
a tail part 162 as a board connecting part connected to a lower end of the outer side connecting part 165,
an upper connecting part 164 connected to the upper end of the outer side connecting part 165, and
an inner side connecting part 166 connected to the lower end of the upper connecting part 164 and facing the outer side connecting part 165. The second terminals 161 may be integrated with the second housing 111 by over-molding or insert molding. That is, the second housing 111 is molded by filling a cavity of a mold in which the second terminals 161 are set in advance with an insulating material such as a synthetic resin.

As a result, the second terminal 161 is integrally attached to the terminal supporting wall 112a such that at least a portion thereof is embedded in the terminal supporting wall 112a of the second protruding part 112 in the second housing 111, and at least a portion of the surface of the outer side connecting part 165, the upper connecting part 164, and the inner side connecting part 166 are exposed on an outer surface, upper surface, and inside surface of the terminal supporting wall 112a. Note that the surfaces of the outer side connecting part 165 and the inner side connecting part 166 function as contacting parts, and contact the first terminal 61 that the first connector 10 is provided with. Furthermore, the tail part 162 extends to an outer side in the width direction of the second housing 111 from the terminal supporting wall 112a and is connected by soldering or the like to a connection pad connected to a conductive trace of the second board. The tail part 162 is disposed at a position overlapping the tail part 151b of the inner wall 151 when viewed from the longitudinal direction (X-axis direction) of the second connector 101. Note that the conductive trace may be a power line that supplies power, but is typically a signal line. In addition, the signal line is described assuming that the signal line does not transmit a high-frequency signal, but rather transmits a signal of normal frequency (for example, frequency less than 10 [GHz]), which is lower in frequency than high-frequency signals.

Furthermore, the second terminal 161 is not necessarily integrated with the second housing 111 by over-molding or insert molding but may be attached to the second housing 111 by press fitting or the like. Herein, for convenience of description, a case of integrating with the second housing 111 by over-molding or insert molding will be described.

The second high-frequency terminal 171 is a member integrally formed by punching, bending, or the like process on a conductive metal plate, and has: a retained part 173; a tail part 172 serving as a board connecting part connected to a lower end of the retained part 173; and an upper connecting part 175 connected to an upper end of the retained part 173.

The retained part 173 extends in the vertical direction and is a portion that is press-fitted and retained in the second high-frequency terminal stowing groove 116a. As described above, the second high-frequency terminal supporting parts 116 are arranged such that the openings of the second high-frequency terminal stowing grooves 116a face in opposite directions, and therefore the second high-frequency terminals 171 with retainable parts 173 retained in the second high-frequency terminal stowing grooves 116a are also oriented to face in opposite directions. Note that the second high-frequency terminal 171 is not necessarily attached to the second housing 111 by press fitting but may be integrated with the second housing 111 by over-molding or insert molding. Herein, for convenience of description, a case in which the retained part 173 is pressed into and retained by the second high-frequency terminal stowing grooves 116a will be described.

The tail part 172 is bent and connected to the retained part 173, extends in a left-right direction (Y-axis direction), in other words, toward the center in the width direction of the second connector 101, and is connected to the connection pad connected to a conductive trace of the second board by soldering or the like. Note that the aforementioned conductive traces are signal lines, which are typically described as transmitting high-frequency signals of high-frequency (for example, frequency of 10 [GHz] or higher), such as RF signals.

Furthermore, the upper connecting part 175 is bent in an approximate S-shape when viewed from the longitudinal direction of the second connector 101, and a portion bent so as to bulge out toward the center in the width direction of the second connector 101 functions as a contacting part 175a. The contacting part 175a is a portion that contacts a first high-frequency terminal 71 provided by the first connector 10.

The second high-frequency terminal 171 is press-fitted from a mounting surface 101b side into the second high-frequency terminal stowing grooves 116a of the second high-frequency terminal supporting part 116 positioned on the protruding end part 122 and is fixed to the second housing 111 based on the retained part 173 being sandwiched from two sides by inner side surfaces of the second high-frequency terminal stowing grooves 116a. In this state, in other words, in a state in which the second high-frequency terminals 171 are installed in the second housing 111, the contacting parts 175a of the pair of second high-frequency terminals 171 mutually face in opposite directions.

Note that in the example depicted in the drawings, the second high-frequency terminal 171 is formed to have the same dimensions and shape as the first high-frequency terminal 71. Therefore, the first high-frequency terminal 71 can be used as the second high-frequency terminal 171.

Furthermore, the second connector 101 is placed on the surface of the second board with a second solder sheet (not shown) serving as a solder sheet applied to the mounting surface 101b side and is fixed and mounted on the surface of the second board by heating and melting the second solder sheet using a heating furnace or the like. Note that the means for connecting the second shield 150, second terminal 161, second high-frequency terminal 171, and the like to the connection pad or the like of the second board does not necessarily have to be application of a solder sheet, and may be application of solder paste, transfer of cream solder, dipping, jet soldering, or the like; however, for convenience of description, the case of using a second solder sheet will be described.

The second solder sheet contains: a pair of elongated strip shaped long side portions extending linearly and continuously in the longitudinal direction of the second connector 101; a plurality of elongated strip shaped short side portions extending linearly and continuously in the width direction of the second connector 101; and a plurality of rectangular short length portions in which a long side extends in the width direction of the second connector 101 and a short side extends in the longitudinal direction of the second connector 101. Note that two ends of each short side portion are preferably connected to the long side portions. Furthermore, the long side portion and short side portion do not necessarily have to extend continuously and may be intermittent but will be described herein as extending continuously.

Furthermore, a pair of long side portions are provided on a lower surface of the flange part 154 corresponding to the long side parts 150a of the second shield 150, a pair of short side portions are provided on the lower surface of the flange part 154 corresponding to the short side part 150b of the second shield 150, and another pair of short side portions are provided on a lower surface of the tail part 151b of the inner wall 151. Furthermore, each short length portion is provided on a lower surface of the tail part 162 of each second terminal 161 and to a lower surface of the tail part 172 of each second high-frequency terminal 171.

When the second solder sheet provided in this manner is heated and melted, and the second connector 101 is mounted on the surface of the second board, the bent part 152a and the flange part 154, which are continuously connected over an entire circumference to the lower end of the outer wall 152 that is continuous over the entire circumference in the second shield 150, are connected to the connection pads on the surface of the second board without a gap. Therefore, the strength of the second shield 150 connected to the connection pads on the surface of the second board is high, and consequently, the strength of the entire second connector 101 with an outer circumference surrounded by the second shield 150 is high. Furthermore, an electromagnetic shielding effect exerted by the second shield 150, which is connected without a gap to the connection pads on the surface of the second board, is very high, and the second connector 101 with an outer circumference surrounded by the second shield 150 is very effectively electromagnetically shielded. In particular, the smoothness of the lower surface of the flange part 154 is high. Thus, the strength of the second shield 150 connected to the connection pads on the surface of the second board can be made extremely high. Moreover, since no gap is created between the connection pads on the surface of the second board, the electromagnetic shielding effect can also be made extremely high.

Furthermore, each of the protruding end parts 122 at two ends of the second connector 101 in the longitudinal direction are covered by the outer wall 152 of the second shield 150 on the outer wall surface facing an outer side in the longitudinal direction and two sides in the width direction of the second connector 101, the upper surface 122b facing the mating surface 101a of the second connector 101 is covered by the upper wall 153 of the second shield 150, and the inner wall surface 122c facing an inner side in the longitudinal direction of the second connector 101 is covered by the inner wall 151 of the second shield 150. Therefore, an entire circumference is shielded, and the second high-frequency terminal 171 supported by the second high-frequency terminal supporting part 116 formed on the protruding end part 122 is very effectively electromagnetically shielded.

Thus, the second connector 101 can transmit a high-frequency signal even though with a compact and low profile, because the strength and the electromagnetic shielding effect are high. For example, even if the dimensions in the longitudinal, width, and height directions of the second connector 101 are set to 2.9 [mm] or less, 1.9 [mm] or less, and 0.7 [mm] or less, the second high-frequency terminal 171 can transmit a high-frequency signal of approximately 60 [GHz].

Next, the operation of mating together the first connector 10 and the second connector 101 with the above configuration will be described.

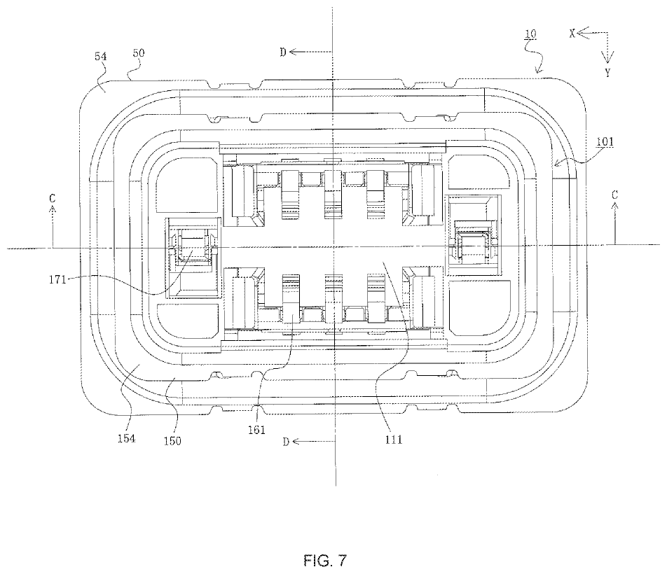

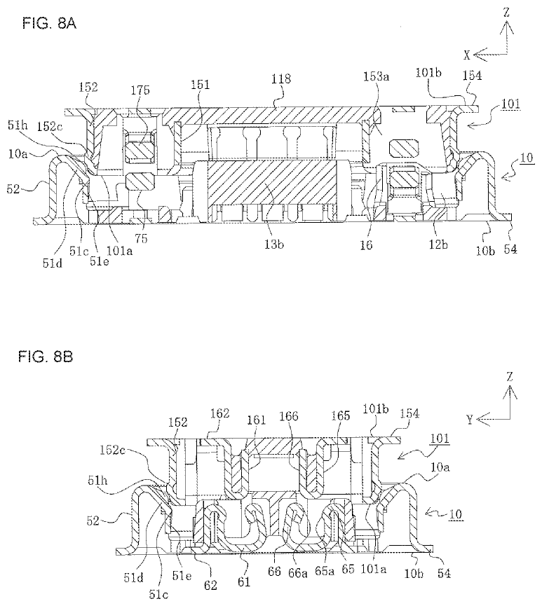

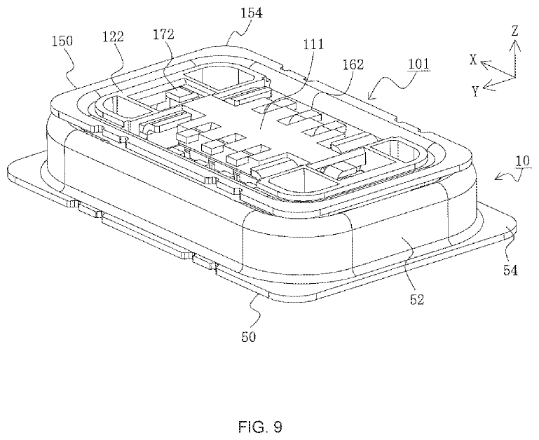

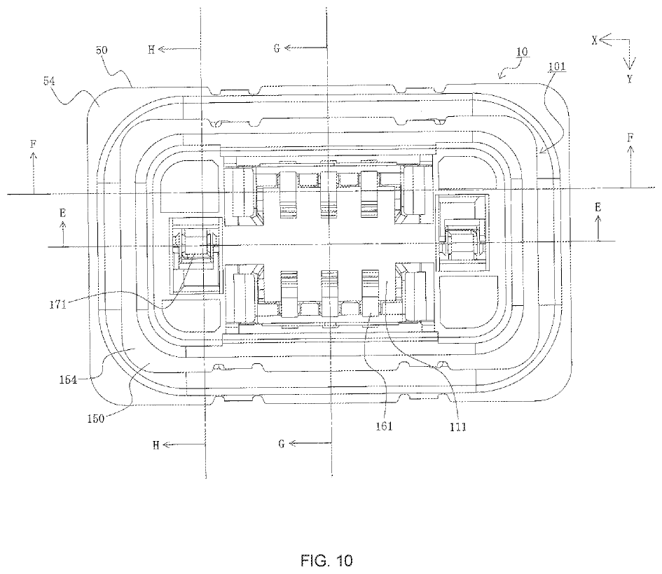

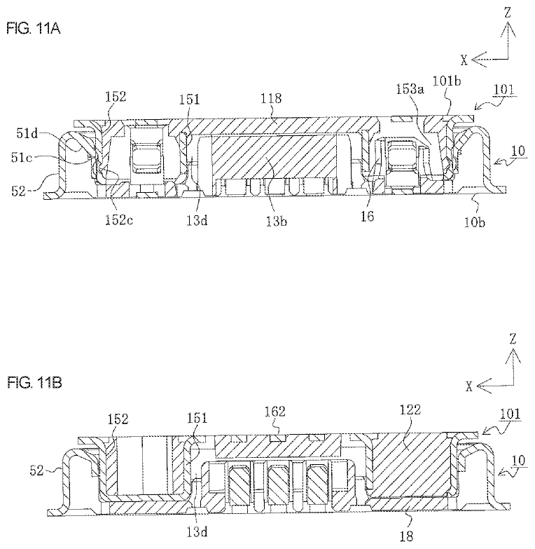

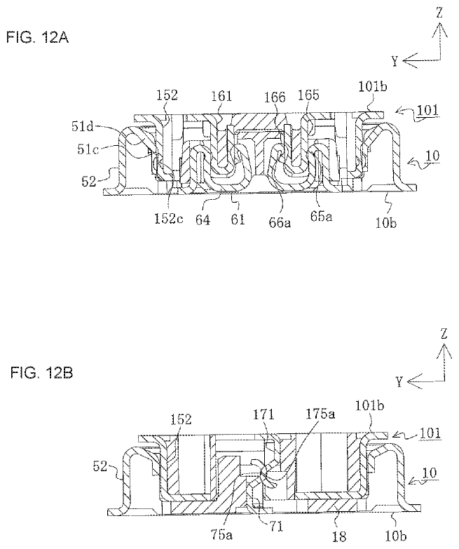

FIG. 7 is a plan view of the initial mating state between the first connector and the second connector in the present Embodiment. FIGS. 8A and 8B are cross section views of the initial mating state between the first connector and the second connector in the present Embodiment. FIG. 9 is a perspective view of the mating completed state of the first connector and the second connector in the present Embodiment. FIG. 10 a plan view of the mating completed state for the first connector and the second connector in the present Embodiment. FIGS. 11A and 11B are side cross section views of the completed mating state of the first connector and the second connector in the present Embodiment. FIGS. 12A and 12B are lateral cross-sectional views of the completed mating state of the first connector and the second connector in the present Embodiment. Note that in FIGS. 8A and 8B, FIG. 8A is a cross section view taken along the line C-C of FIG. 7, FIG. 8B is a cross section view taken along the line D-D of FIG. 7, and in FIGS. 11A and 11B, FIG. 11A is a cross section view taken along the line E-E in FIG. 10, and FIG. 11B is a cross section view taken along the line F-F in FIG. 10. In FIGS. 12A and 12B, FIG. 12A is a cross section view taken along the line G-G in FIG. 10, and FIG. 12B is a cross section view taken along the line H-H in FIG. 10.

In order to mate the first connector 10 and the second connector 101, first, an operator places the mating surface 10a of the first connector 10 and the mating surface 101a of the second connector 101 so as to face each other, and when the position of the first protruding part 13 of the first connector 10 matches the position of the second recessed part 113 of the second connector 101 and the position of the protruding end part 122 of the second connector 101 matches the position of the mating recess part 12b corresponding to the first connector 10, positioning of the first connector 10 and the second connector 101 is complete.

In this state, when the first connector 10 and/or the second connector 101 are moved in a direction approaching a counterpart side, in other words, in a mating direction, the second shield 150 of the second connector 101 is inserted into the stowing part 50d of the first shield 50 of the first connector 10, the first protruding part 13 of the first connector 10 is inserted into the second recessed part 113 of the second connector 101, and the protruding end part 122 of the second connector 101 is inserted into the mating recess part 12b of the first connector 10.

Note that the connecting part 53 of the first shield 50 is present on the mating surface 10a of the first connector 10 so as to surround a circumference thereof, and the outer wall 152 and the upper wall 153 of the second shield 150 are present on the mating surface 101a of the second connector 101. Therefore, the mating surface 10a of the first connector 10 and the mating surface 101a of the second connector 101 will not be damaged or broken even when coming into contact with each other.

Furthermore, in the initial mating state depicted in FIG. 7 and FIGS. 8A and 8B, or in other words, in a state where the portion near the mating surface 101a of the second shield 150 of the second connector 101 enters slightly into the stowing part 50d of the first shield 50 of the first connector 10, the portion near the mating surface 101a of the outer wall 152 at the corner part 150c of the second shield 150 comes into contact with the gradual oblique surface part 51h near the upper end of the mating positioning part 51b (near the mating surface 10a) in the corner parts 50c of the first shield 50, and is inserted into the stowing part 50d while in contact with and being guided by the gradual oblique surface part 51h as depicted in FIGS. 8A and 8B. Thereby, the second connector 101 is positioned with respect to the first connector 10. Note that the corner part 50c included in the mating positioning part 51b is integrated with the corner part 17 of the first housing 11, and the back side thereof is filled with the insulating material constituting the first housing 11, and therefore the corner part is robust. Therefore, the mating positioning part 51b has high robustness, and even if the portion near the mating surface 101a of the second shield 150 of the second connector 101 comes into contact with the mating positioning part 51b, the mating positioning part 51b will not be deformed or damaged.

Furthermore, the portion near the mating surface 101a of the outer wall 152 at the corner part 150c of the second shield 150 comes into contact with the oblique surface part 51d of the mating spring part 51a of the first shield 50 after coming into contact with the gradual oblique surface part 51h. As a result, damage to the mating spring part 51a can be reduced.

Thus, as depicted in FIGS. 9 to 12B, when the mating of the first connector 10 and the second connector 101 is completed, the first terminal 61 and the second terminal 161 conduct electricity, and the first high-frequency terminal 71 and the second high-frequency terminal 171 achieve an electrically conductive state.

Specifically, the pair of terminal support walls 112a of the second protruding part 112 of the second housing 111 are inserted into the pair of inner recessed groove parts 12a of the first housing 11, and as depicted in FIG. 12A, the contact part 65a of the outer side connecting part 65 and the contact part 66a of the inner side connecting part 66 of the first terminal 61 that protrude into the inner groove portion 12a and face each other come into contact with the outer side connecting part 165 and the inner side connecting part 166 of the second terminal 161 exposed on the outer surface and the inside surface of the terminal support wall 112a.

At this time, the lower connecting parts 64 of the first terminal 61 and a vicinity thereof have an essentially U-shaped shape and are elastically deformable, such that the interval between the mutually facing outer side connecting part 65 contacting part 65a and the inner side connecting part 66 contacting part 66a is elastically expandable. Therefore, the interval between the contacting part 65a on the outer side connecting part 65 and the contacting part 66a on the inner side connecting part 66 are elastically pushed apart by the second terminal 161 inserted therebetween and as a reaction thereof, the second terminal 161 is elastically sandwiched from two sides by the contacting part 65a of the outer side connecting part 65 and the contacting part 66a of the inner side connecting part 66. As a result, the contacting part 65a of the outer side connecting part 65 of the first terminal 61 and the outer side connecting part 165 of the second terminal 161, as well as the contacting part 66a of the inner side connecting part 66 of the first terminal 61 and the inner side connecting part 166 of the second terminal 161 maintain contact and do not separate even when subjected to shock or vibration and thus can maintain a stable state of electrical conduction. Furthermore, the mutually corresponding first terminal 61 and second terminal 161 are in a state of contact at two points, a so-called two-point contact, and even if contact at one point is released, the contact at the other point is maintained, and thus a contact state can be stably maintained.

Furthermore, the first high-frequency terminal supporting part 16 positioned in the mating recess part 12b is inserted into the first high-frequency terminal stowing recessed part 116c of the protruding end part 122, and the contact part 75a of the first high-frequency terminal 71 and the contact part 175a of the second high-frequency terminal 171 contact each other as depicted in FIG. 12B. At this time, the contacting parts 75a and 175a of the first high-frequency terminal 71 and the second high-frequency terminal 171 are elastically displaceable in the width direction of the first connector 10 and the second connector 101 because the bent upper connecting parts 75 and 175 are themselves elastically deformable. As a result, the contacting part 75a of the first high-frequency terminal 71 and the contacting part 175a of the second high-frequency terminal 171 corresponding to each other maintain contact and do not separate even when subjected to shock or vibration, and thus can maintain a stable state of electrical conduction. Note that the first high-frequency terminal 71 and the second high-frequency terminal 171 corresponding to each other contact each other at only one point, a so-called single contact point, such that no unintended stubs or divided circuits are formed in the signal transmission line from the tail part 72 of the first high-frequency terminal 71 to the tail part 172 of the second high-frequency terminal 171. Therefore, the impedance of the transmission line can be stabilized and favorable SI characteristics can be achieved.

In this manner, the first high-frequency terminal 71 and second high-frequency terminal 171, which are in contact with each other, have entire circumferences that are continuously surrounded by the inner wall 51 and outer wall 52 of the first shield 50 and the inner wall 151 and outer wall 152 of the second shield 150, and moreover, are continuously surrounded, thereby being extremely effectively shielded. Therefore, the impedance of the transmission line of a signal from the tail part 72 of the first high-frequency terminal 71 to the tail part 172 of the second high-frequency terminal 171 is stabilized, and favorable SI characteristics can be achieved.

Furthermore, when the second shield 150 of the second connector 101 is inserted into the stowing part 50d of the first shield 50 of the first connector 10, the outer surface of the outer wall 152 of the second shield 150 contacts or approaches the inner surface of the inner wall 51 of the first shield 50 and as depicted in FIG. 11A and FIG. 12A, the engaging protruding part 152c formed on the outer wall 152 of the second shield 150 or the outer wall 152 and the engaging protruding part 51c formed on the inner wall 51 of the first shield 50 are engaged and come into contact. Note that the mating spring part 51a of the inner wall 51, in which the engaging protruding part 51c is formed, is separated from another portion by the slit part 53a at two ends thereof and is relatively flexible; and a state of engagement with the engaging protruding part 152c of the outer wall 152 of the second shield 150 can be reliably maintained. As a result, the first shield 50 and the second shield 150 become locked and release of the mating state between the first connector 10 and the second connector 101 is prevented. Furthermore, the first shield 50 and the second shield 150 are in contact with each other and are electrically conductive and at equipotential, and therefore, electromagnetic shielding is improved. Note that the engaging protruding part 51c is the portion that engages with and contacts the engaging protruding part 152c; however, electromagnetic shielding properties can be improved in a similar manner without providing the engaging protruding part 152c on the outer wall 152 and having the surface of the outer wall 152 function as a contact point part with the engaging protruding part 152c.

Next, the configuration of the plating layer formed on the extension surfaces that are the outer surfaces of the first shield 50 and second shield 150 that are conductive members in the present Embodiment will be described.

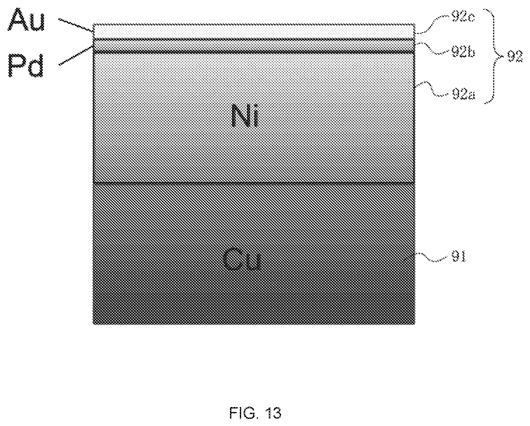

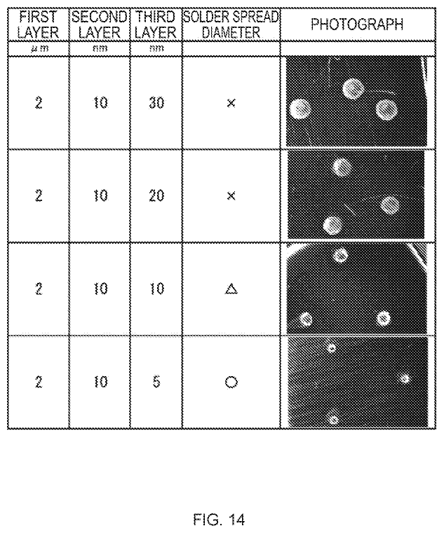

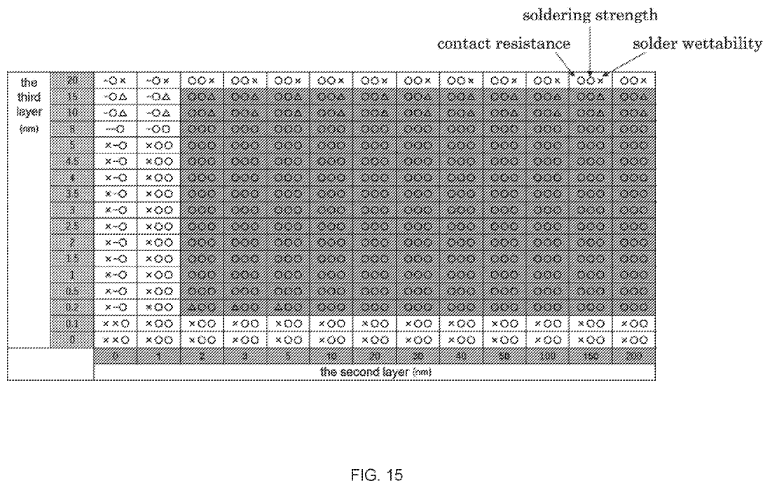

FIG. 13 is a schematic cross section view in the vicinity of the surface of the conductive member depicting a plating layer structure according to the present Embodiment; FIG. 14 is a diagram depicting test results of solder wetting and spreading according to the present Embodiment; and FIG. 15 is a table depicting test results for changes to the thickness of the second and third layers in the present Embodiment.

In the present Embodiment, the area near the overall outer surface of the first shield 50 and second shield 150 that are conductive members have a plating configuration as depicted in FIG. 13.

In the diagram, 91 is a conductive metal base material that constitutes the first shield 50 and second shield 150 that are conductive members and, for example, are composed of copper (Cu) or a copper alloy.

In addition, 92 is a plating layer formed on the outer surface of the metal base material 91 and includes a first layer 92a, a second layer 92b, and a third layer 92c.

The first layer 92a is a nickel (Ni) or nickel alloy plating layer and the thickness thereof is preferably 1 to 3 [μm]. Note that the first layer 92a has the function of preventing diffusion of copper from the metal base material 91 to the second layer 92b and third layer 92c.

The second layer 92b is a platinum group metal or platinum group metal alloy plating layer and the thickness thereof is preferably 2 [nm] or more. Note that from a cost or the like perspective, the thickness is preferably 200 [nm] or less so the thickness can be said to be preferably 2 to 200 [nm]. Furthermore, from the perspective of sufficiently preventing mutual diffusion of the metal of the first layer 92a and the metal of the third layer 92c, the thickness thereof is more preferably 5 to 25 [nm]. In addition, any of ruthenium (Ru), rhodium (Rh), palladium (Pd), osmium (Os), iridium (Ir), or platinum (Pt) can be selected as the platinum group metal; however, the most preferred is palladium. Furthermore, examples of platinum group metal alloys include: any alloy containing 50[%] or more of ruthenium, rhodium, palladium, osmium, iridium, or platinum; however, a palladium alloy containing 50[%] or more of palladium (for example, PdNi or the like) is more preferable.

The third layer 92c is a gold or gold alloy plating layer and the thickness thereof is preferably 0.2 to 15 [nm] and more preferably 0.5 to 8 [nm]. In addition, examples of gold alloys include: gold alloys containing 90[%] or more gold (for example, AuCo, AuCu, AuNi, AuFe, and the like). However, in the case of an alloy with a platinum group metal, a gold alloy with 20[%] or more of gold (for example, AuPd, AuPt, or the like) is sufficient.

In the present Embodiment, the numerical range of the thicknesses of the second layer 92b and the third layer 92c are set based on experimental results (test results) such as those depicted in the table in FIG. 15. In FIG. 15, the horizontal axis indicates the numerical values [nm] of the thickness of the second layer 92b and the vertical axis indicates the numerical values [nm] of the thickness of the third layer 92c. In addition, each of the cells (boxes) of the table indicate test results of contact resistance tests, soldering strength tests, and solder wettability tests using one of the symbols O, Δ, and X. The symbol O means good, the symbol Δ means somewhat good, and the symbol×means failed.

In the experiment, a plating layer 92 was formed on the surface of each of the test pieces of a prescribed size composed of the metal base material 91 so as to achieve second layer 92b and third layer 92c thicknesses with a numerical value corresponding to each cell. Next, each of the test pieces were used to perform contact resistance tests, soldering strength tests, and solder wettability tests. Note that as depicted in FIG. 15, the thickness of the second layer 92b was varied from 0 to 200 [nm] and the thickness of the third layer 92c was varied from 0 to 20 [nm].

In the contact resistance test, the level of contact resistance on the plating layer 92 surface of each test piece was measured. The test pieces with a contact resistance less than a first threshold were evaluated as good, test pieces with a contact resistance above the first threshold but below a second threshold were evaluated as somewhat good, and test pieces with contact resistance above the second threshold were evaluated as failed.

In addition, in the soldering strength test, additional test pieces were soldered to the plating layer 92 surface of each test piece. A tensile force was applied to these separate test pieces and the tensile force causing the soldered portion to break was measured. Test pieces with a tensile force above a first threshold were evaluated as good, test pieces with a tensile force lower than the first threshold but above a second threshold were evaluated as somewhat good, and test pieces with a tensile strength less than the second threshold were evaluated as failed.

Furthermore, as depicted in FIG. 14, in the solder wettability test, several solder balls (for example, particle diameter 0.6 [mm]) were placed on the surface of each test piece plating layer 92 and a heating device (for example, a solder reflow oven) was used, and the spread diameter after heating was measured. Test pieces where the spread diameter was less than a first threshold were evaluated as good, test pieces where the spread diameter was greater than the first threshold but less than a second threshold were evaluated as somewhat good, and test pieces with a spread diameter greater than the second threshold were evaluated as failed.

As depicted in FIG. 15, in the experimental results, there were no failures in test result evaluation for a second layer 92b thickness in the range of 2 to 200 [nm] and a third layer 92c thickness in the range of 0.2 to 15 [nm] and so can be used as the second terminal 161 that is a conductive member. Furthermore, when the thickness of the third layer 92c was restricted to the range of 0.5 to 8 [nm], the test results did not include failure or somewhat good evaluation, in other words, the test result evaluation was good for all cases; therefore, this was found to be more desirable. Note that from FIG. 15, it is anticipated that test result evaluations will all be good for second layer 92b thickness of greater than 200 [nm], but when considering cost and the like, a value greater than 200 [nm] is not realistic so the upper limit of the thickness of the second layer 92b was set to 200 [nm].

As depicted in FIG. 14, if the thickness of the third layer 92c that is a gold or gold alloy plating layer is thin, the solder spread diameter will be small reducing solder wettability, in other words, spread and wetting of solder occurs less readily enabling suppressing of solder wicking. Therefore, spreading of solder to the engaging protruding part 51c that is the contact point part of the first shield 50 and to the outer wall 152 that is the contact point part of the second shield 150 or to the engaging protruding part 152c formed on the outer wall 152 can be prevented. On the other hand, reduction in solder wettability causes difficulty in soldering the flange part 54 that is the board connecting part of the first shield 50 and the flange part 154 that is the board connecting part of the second shield 150, reduces strength of the soldered portion, and reduces soldering strength of the flange part 54 on the first board surface and soldering strength of the flange part 154 on the second board surface. In addition, if the thickness of the third layer 92c that is a gold or gold alloy plating layer is thin, contact resistance increases and in addition, the third layer 92c wears more readily. However, forming the second layer 92b that is a platinum group metal or platinum group metal alloy plating layer below the third layer 92c with a prescribed thickness or thicker, enables reducing the contact resistance of the third layer 92c and also prevents wear.

In this manner, by setting the third layer 92c thickness to 0.2 to 15 [nm] and the thickness of the second layer 92b that is below the third layer 92c to 2 to 200 [nm], solder wettability can be suitably maintained, connection strength of the first shield 50 flange part 54 and the second shield 150 flange part 154 can be improved, and prevention of solder wicking and reduction of contact resistance of the first shield 50 engaging protruding part 51c and the second shield 150 engaging protruding part 152c can be achieved without forming a solder barrier.

Note that in the present Embodiment, the thicknesses of the second layer 92b and third layer 92c were measured using X-ray electron spectroscopy, commonly known as XPS. XPS is a method for measuring components of a sample and in general can measure substances with a depth of roughly 0.2 to 6 [nm]. In addition, the sample surface layer is scraped by ion sputtering (sputter etching using ions). Ion sputtering can be used to scrape roughly 0.2 to 1 [nm]. Note that the amount of scraping can be adjusted.

In the present Embodiment, measurement was performed by repeating the operations of measuring a sample surface substance using XPS, scraping the surface layer of the sample using ion sputtering, and measuring a sample surface substance using XPS. For example, after measuring the third layer 92c that is the surface layer using XPS and detecting gold or gold alloy, just 0.2 [nm] of the third layer 92c that is the surface is scraped using ion sputtering; next, in measuring using XPS, if gold or gold alloy can be detected, the thickness of the third layer 92c composed of gold or gold alloy can be determined to be 0.2 [nm] or more.

In this manner, in the present Embodiment, the first connector 10 includes the first housing 11 and the first shield 50. Furthermore, the first shield 50 includes a main body part containing from the location that the engaging protruding part 51c is formed on the inner wall 51 as a contact point part to the flange part 54 as the board connecting part, including the connecting part 53 and outer wall 52; the flange part 54 positioned at the first end of the main body part; and the engaging protruding part 51c positioned at the second end of the main body part. Surrounding the periphery of the first connector 10, the main body part, flange part 54, and engaging protruding part 51c each include exposed surfaces exposed outside the first housing 11. The flange part 54 is formed along the entire periphery of the first connector 10. The main body part, flange part 54, and engaging protruding part 51c each include the metal base material 91 and the first layer 92a, second layer 92b, and third layer 92c formed on the metal base material 91. The first layer 92a is a nickel or nickel alloy plating layer, the second layer 92b is a platinum group metal or platinum group metal alloy plating layer, the third layer 92c is a gold or gold alloy plating layer, and the thickness of the third layer 92c is 0.2 to 15 [nm].

In addition, in the present Embodiment, the second connector 101 includes the second housing 111 and second shield 150. Furthermore, the second shield 150 includes a main body part containing from the location that the engaging protruding part 152c is formed on the outer wall 152 as a contact point part to the flange part 154 as the board connecting part; the flange part 154 positioned at the first end of the main body part; and the engaging protruding part 152c positioned at the second end of the main body part. Surrounding the periphery of the second connector 101, the main body part, flange part 154, and engaging protruding part 152c each include exposed surfaces exposed outside the second housing 111. The flange part 154 is formed along the entire periphery of the second connector 101. The main body part, flange part 154, and engaging protruding part 152c each include the metal base material 91 and the first layer 92a, second layer 92b, and third layer 92c formed on the metal base material 91. The first layer 92a is a nickel or nickel alloy plating layer, the second layer 92b is a platinum group metal or platinum group metal alloy plating layer, the third layer 92c is a gold or gold alloy plating layer, and the thickness of the third layer 92c is 0.2 to 15 [nm].

As a result, solder wettability can be suitably maintained, the connection strength of the flange parts 54 and 154 can be improved, and prevention of solder wicking and reduction of contact resistance of the engaging protruding parts 51c and 152c can be achieved without forming a solder barrier between the flange parts 54 and 154 and engaging protruding parts 51c and 152c. Therefore, a solder barrier does not have to be formed on the minute dimension first shield 50 and second shield 150 used for the extremely small size and low profile first connector 10 and second connector 101. Thus, the structure of the first connector 10 and the second connector 101 can be simplified, cost can be reduced, and reliability can be improved.

In addition, the first housing 11 is integrally formed with the first shield 50 and the second housing 111 is integrally formed with the first shield 150 [sic]. Furthermore, the flange parts 54 and 154 are soldered to the first board and the second board around the entire periphery. Furthermore, the flange parts 54 and 154 are continuous around the entire periphery. Furthermore, the engaging protruding parts 51c and 152c can be formed on the four sides of the first shield 50 and the second shield 150. Furthermore, the connecting part 53 bent towards the inside of the first connector 10 can be formed on the upper end of the first shield 50. Furthermore, the plating layer 92 is formed over the entirety of the first shield 50 and the second shield 150. Furthermore, the thickness of the third layer 92c is preferably 0.5 to 8 [nm]. Furthermore, the platinum group metal is preferably palladium or a palladium alloy and the thickness of the second layer 92b is 2 to 200 [nm].

Note that the disclosure herein describes features relating to suitable exemplary embodiments. Various other embodiments, modifications, and variations within the scope and spirit of the claims appended hereto will naturally be conceived of by those skilled in the art upon review of the disclosure herein.

The present disclosure can be applied to a connector and a connector pair.

1. A connector, comprising:
a housing; and
a shield,
wherein
the shield includes a main body part, a board connecting part positioned at a first end of the main body part, and a contact point part positioned at a second end of the main body part, and surrounds a periphery of the connector,
the main body part, board connecting part, and contact point part each include exposed surface that is exposed outside the housing,
the board connecting part is formed around the entire periphery of the connector,
the main body part, board connecting part, and contact point part each include a metal base material and first to third plating layers formed on the metal base material, and
the first layer is a nickel or nickel alloy plating layer, the second layer is a platinum group metal or platinum group metal alloy plating layer, the third layer is a gold or gold alloy plating layer, and the thickness of the third layer is 0.2 to 15 [nm].

2. The connector according to claim 1, wherein the housing is integrally formed with the shield.

3. The connector according to claim 1, wherein the board connecting part is soldered to a board around the entire periphery.

4. The connector according to claim 1, wherein the board connecting part is a flange that is continuous around the entire periphery.

5. The connector according to claim 1, wherein the contact point part can form four sides of the shield.

6. The connector according to claim 1, wherein a bent part bent toward the inside of the connector can be formed at an upper end of the shield.

7. The connector according to claim 1, wherein the plating layer is formed over the entirety of the shield.

8. The connector according to claim 1, wherein a thickness of the third layer is 0.5 to 8 [nm].

9. The connector according to claim 1, wherein the platinum group metal is palladium or a palladium alloy and the thickness of the second layer is 2 to 200 [nm].

10. A connector pair, comprising the connector according to claim 1 and a counterpart connector that mates with the connector.

11. The connector pair according to claim 10, wherein
the counterpart connector includes a housing and a shield,
the shield includes a main body part, a board connecting part positioned at a first end of the main body part, and a contact point part positioned at a second end of the main body part, and surrounds a periphery of the counterpart connector,
the main body part, board connecting part, and contact point part each include exposed surface that is exposed outside the housing,
the board connecting part is formed around the entire periphery of the counterpart connector,
the main body part, board connecting part, and contact point part each include a metal base material and first to third plating layers formed on the metal base material, and
the first layer is a nickel or nickel alloy plating layer, the second layer is a platinum group metal or platinum group metal alloy plating layer, the third layer is a gold or gold alloy plating layer, and the thickness of the third layer is 0.2 to 15 [nm].
